(19) United States
(12) Patent Application Publication
(10) Pub. No.: US 2025/0289495 A1
(43) Pub. Date: Sep. 18, 2025

(54) CENTERING TORQUE FOR PROMOTING STEERING STABILITY

(71) Applicant: Rivian IP Holdings, LLC, Irvine, CA (US)

(72) Inventors: Deane Mathew WICHELT, Buckeye, AZ (US); Shuyang WANG, Laguna Niguel, CA (US); Nicholas Alan CHENOWETH, Mission Viejo, CA (US); Michael Fei-Kit TUNG, Irvine, CA (US)

(21) Appl. No.: 19/025,915

(22) Filed: Jan. 16, 2025

Related U.S. Application Data
(60) Provisional application No. 63/564,922, filed on Mar. 13, 2024.

(51) Int. Cl. B62D 5/04

(52) U.S. Cl. CPC B62D 5/0466; B62D 5/0415

(57) ABSTRACT

A vehicle includes a motor coupled to steered wheels by a differential. A steering mechanism is coupled to the steered wheels and changes the steering angle of the steered wheels in response to torque applied to a steering column. A power assistance actuator facilitates turning of the steered wheels, such as by amplifying torque applied by the driver to the steering wheel, which amplified torque is converted into a transverse force to turn the steered wheels. The assistance torque commanded from the power assistance actuator may be determined based on (a) a driver torque applied by the drive to steering wheel and (b) a small (e.g., less than 4 Nm) centering torque that urges the steered wheels to a central position. The centering torque may increase with increasing motor torque, increase with increasing steering wheel angle, and decrease with increasing vehicle speed.

### RELATED APPLICATION

This application claims the benefit of U.S. Application Ser. No. 63/564,922 filed Mar. 13, 2024, and entitled “CENTERING TORQUE FOR PROMOTING STEERING STABILITY”, which is hereby incorporated herein by reference in its entirety.

### INTRODUCTION

The present disclosure relates to power assisted steering.

### SUMMARY

The present disclosure describes an approach for promoting steering stability (e.g., at low speeds and high motor torque) by applying a centering torque. In one aspect, a vehicle includes a chassis having a plurality of wheels mounted thereto, the plurality of wheels including a left steered wheel and a right steered wheel. The vehicle includes a drive motor configured to drive the left steered wheel and the right steered wheel to induce movement of the vehicle over a surface. An assistance actuator is configured to output an assistance torque. A steering mechanism is configured to transmit the assistance torque to the left steered wheel and the right steered wheel to change a steering angle of the left steered wheel and the right steered wheel. A steering handle is configured to be actuated by a driver of the vehicle. A controller is coupled to the assistance actuator and to the steering handle. The controller is configured to select the assistance torque based on: a first component having a first magnitude and a first direction corresponding driver torque applied to the steering handle; and a second component having a second magnitude and a second direction, the second direction corresponding to rotation of the left steered wheel and the right steered wheel toward a central position corresponding to movement of the vehicle in a straight line.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3A is schematic diagram illustrating a drivetrain of a vehicle.

FIG. 3B is schematic diagram illustrating a steering system of a vehicle.

FIG. 4 is a process flow diagram of a method for applying a centering torque in accordance with an embodiment of the present invention.

FIGS. 5 is a plot illustrating centering torque as a function of motor torque and steering wheel angle in accordance with an embodiment of the present invention.

### DETAILED DESCRIPTION

A steering system commands assistance torque to assist the driver in turning the vehicle. The assistance torque may be determined as a combination (e.g., sum) of a centering torque and a driver assistance torque. The driver assistance torque corresponds to torque applied by the driver to the steering wheel. The centering torque urges the steered wheels to a central position to promote steering stability at low speeds and high motor torque. The centering torque is relatively small (e.g., less than 5 Nm) and is intended to be imperceptible to the driver.

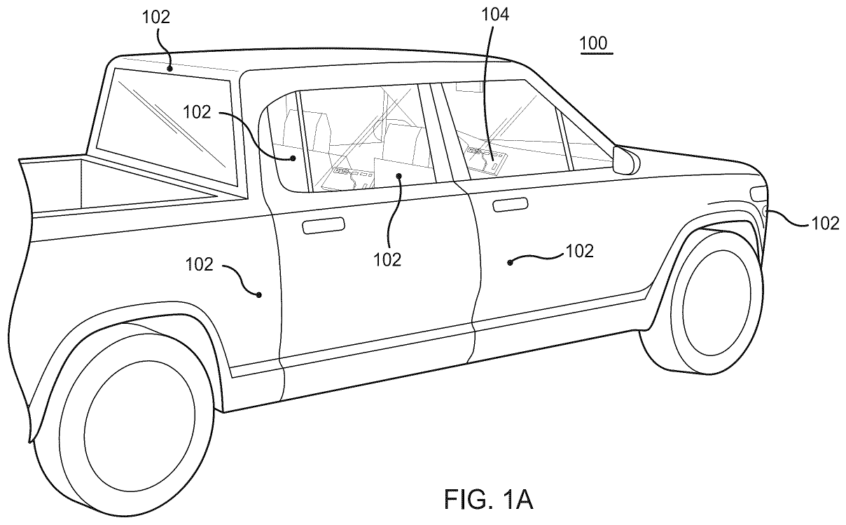

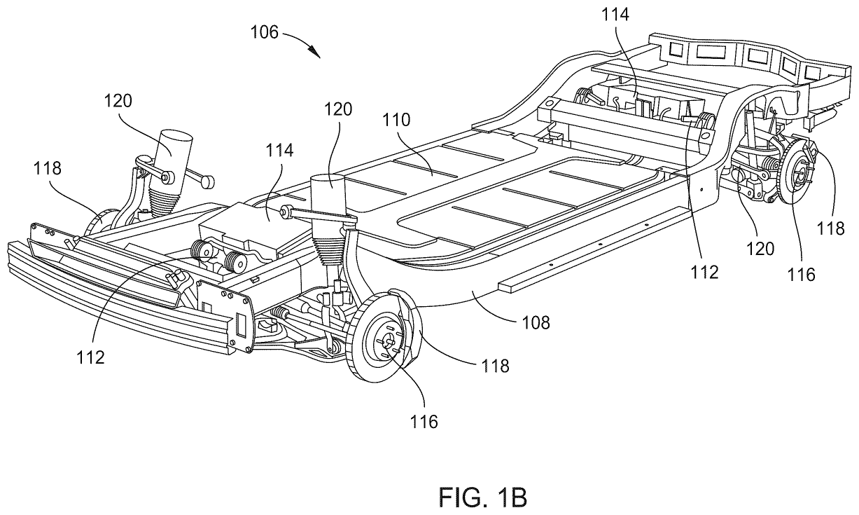

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more power modules 114, such as power modules for each drive unit 112 or pair of drive units 112. The power modules 114 may include inverters configured to convert direct current (DC) from the battery 110 into alternating current (AC) supplied to the motors of the drive units 112. The power modules 114 further facilitate operation of the motors of the drive units as generators to provide regenerative braking. The power modules 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein. Likewise, non-vehicular applications that use an inverter may also benefit from the approach described herein.

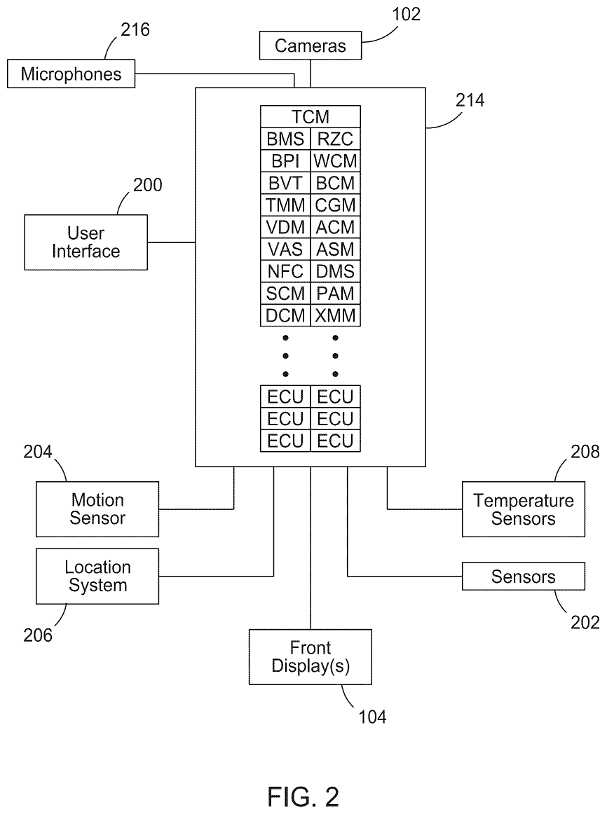

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power modules 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power modules 114 as described in greater detail below.

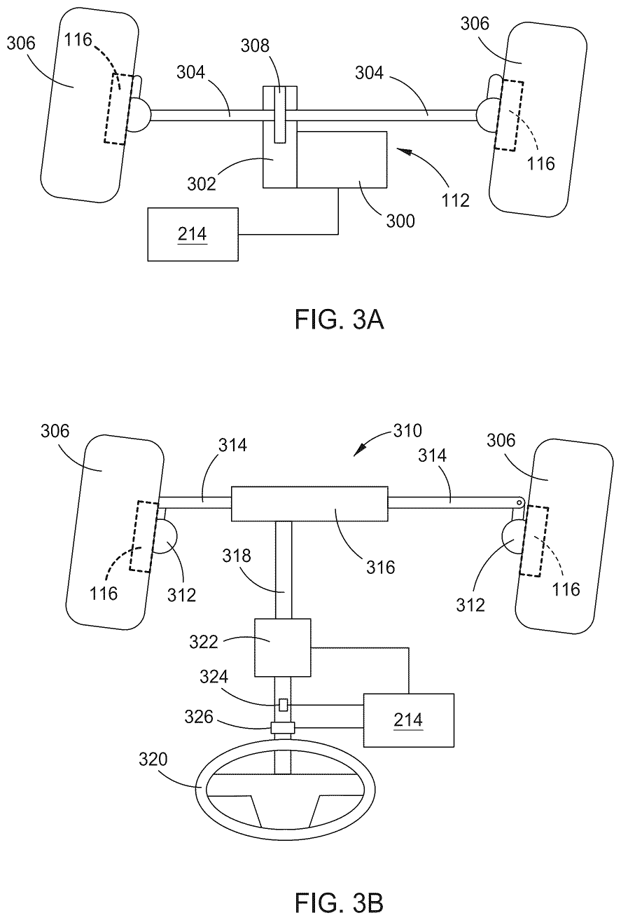

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3A, each drive unit 112 may include a motor 300, such as an electric motor. The output shaft of the motor 300 may be coupled to a reduction gear set 302 coupled to axles 304 that transfer torque from the gear set 302 to the hubs 116. Road wheels 306 are mounted to the hubs 116. The gear set 302 includes one or more gears that induce rotation of the axles 304 at a reduced rotational speed relative to the output of the motor 300 in order to apply increased torque to the road wheels 306. The gear set 302 may include a differential 308. The differential 308 enables torque to be transferred to the axles 304 at different speeds. The differential 308 therefore accommodates different speeds of the road wheels 306 when turning or in other situations. The differential 308 may be implemented using any approach known in the art. The differential 308 may be an open differential (e.g., may lack structures for limiting the difference in speed between the axles 304) or may have some sort of locking mechanism (e.g., a locking differential) or limiting mechanism (e.g., a limited slip differential).

The control system 214 may be coupled to a sensor in the motor 300 or other component in the drive unit to obtain a measurement of torque to the control system 214. The measurement of torque may be, or be proportional to, torque actually output by the motor 300, as opposed to a commanded torque output by the control system 214. The measurement of torque therefore accounts for any slipping of road wheels 306 that limits the torque output by the motor 300.

Referring to FIG. 3B, the steering system 310 of the vehicle 100 may have the illustrated configuration. The illustrated configuration is exemplary only and any other steering system known in the art may benefit from the approach described herein.

The steering system 310 may include steering knuckles 312 that mount the hubs 116 to the chassis such that the hubs may rotate about axes of rotation defined by the steering knuckles 312 in order to change the angle of the road wheels 306 and turn the vehicle 100.

The steering knuckles 312 are coupled by tie rods 314 to a steering mechanism 316 the steering mechanism 316 may be embodied as a rack-and-pinion, circulating ball, or other type of steering mechanism that translates rotation of a steering column 318 into translational motion of the tie rods 314. The steering mechanism 316 may also be implemented as a pulley system or any other type of steering mechanism 316 known in the art.

The steering column 318 is connected to the steering wheel 320 due to direct mounting or some other intervening mechanism. The steering wheel 320 is one example of a handle that is held by the driver to induce rotation of the steering column 318. However, other handles may be used, such as a yoke, a lever, or other structure configured to be grasped in the hand of the driver.

The steering system 310 may include some form of power assistance that amplifies torque applied to the steering wheel 320 to force applied to the tie rods 314. In the illustrated embodiment, the power assistance is an electric power steering actuator 322 that is coupled to the steering column 318 and applies torque to the steering column 318. The electric power steering actuator 322 may be controlled based on output of a torque sensor 324 that senses torque applied to the steering wheel 320. The torque sensor 324 may be implemented as a strain gauge, a torsion bar and displacement sensor, or any other type of torque sensor known in the art, particularly those used in power steering systems.

The control system 214 may receive the output from the torque sensor 324 and output an assistance torque value to the electric power steering actuator 322. The electric power steering actuator 322 then attempts to apply a torque corresponding to the commanded assistance torque to the steering column 318.

A steering wheel sensor 326 may sense rotation of the steering wheel 320. The control system 214 may use the output of the steering wheel sensor 326 to determine the assistance torque. Other inputs that may be used by the control system 214 include the speed of the vehicle 100. For example, at higher speeds, a lower assistance torque may be needed.

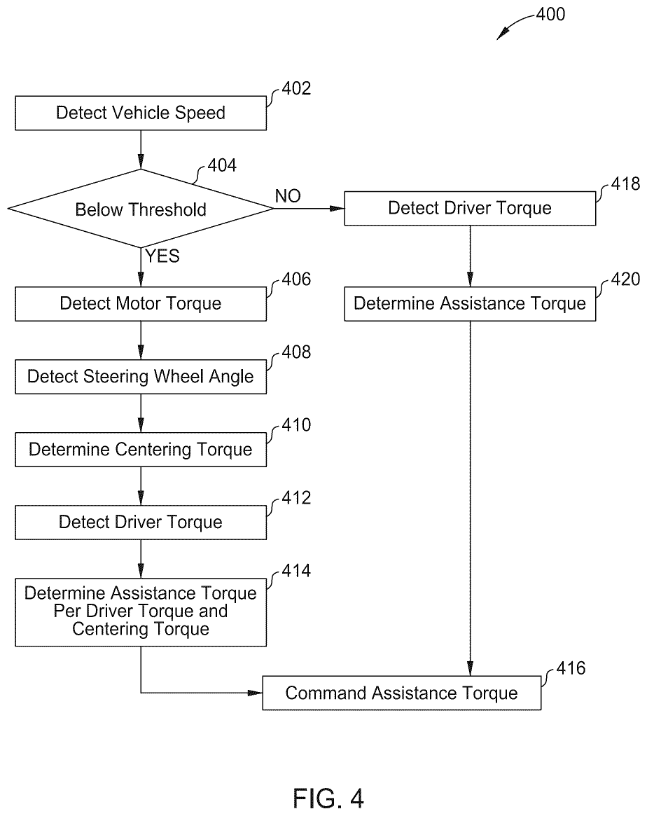

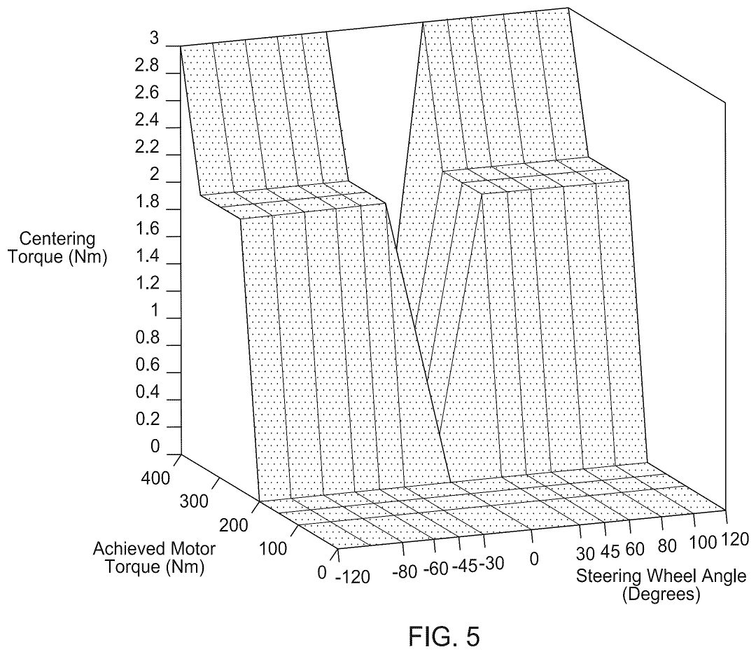

Referring to FIGS. 4 and 5, electric vehicles are capable of generating a large amount of torque, particularly at low speeds. The method 400 may be used to promote stable steering of the vehicle when operating at low speeds and high torque output of the motor 300. In particular, the method 400 facilitates stable steering when torque from a motor is transmitted to the road wheels 306 through a differential 308. The method 400 may be helpful in other contexts, such as when road wheels 306 are driven by separate motors. The method 400 may be executed by the control system 214 or some other component of the vehicle 100.

The method 400 includes detecting, at step 402, the speed of the vehicle 100. If, at step 404, the speed of the vehicle is determined to be below a speed threshold, the appropriateness of applying a centering torque and possibly an amount of centering torque is determined.

For example, the method 400 may include detecting, at step 406, the torque output by the motor 300, e.g., the achieved torque of the motor 300, which may be less than a commanded torque. The method 400 may further include detecting, at step 408, the steering wheel angle, such as from the output of the steering wheel sensor 326. The steering wheel angle may be a proxy for the steering angle of the road wheels 306 such that, in some embodiments, the steering angle of the road wheels 306 may instead be detected at step 408.

A centering torque may then be determined at step 410. The centering torque is a torque that tends to urge the road wheels 306 to a central position. The central position may be defined as the orientation of the road wheels 306 at which the vehicle 100 will drive in a straight line. Accordingly, when the road wheels 306 are turned to the left (causing a left turn), the centering torque will urge the road wheels 306 to the right. When the road wheels 306 are turned to the right (causing a right turn), the centering torque will urge the road wheels to he left.

The centering torque may be a fixed value or may be varied based on the state of the vehicle 100. For example, the centering torque may:
Increase with increasing torque of the motor 300.
Increase with increasing steering wheel angle.
Decrease with increasing speed of the vehicle.

For example, FIG. 5 illustrates a function for determining the magnitude of the centering torque as a function of steering wheel angle and torque actually output by the motor 300 (“achieved motor torque”). The illustrated function increases centering torque with an increase in achieved motor torque and increases centering torque with increasing steering wheel angle. The illustrated function may be defined in a lookup table accessed by the control system 214 or by a mathematical function. The illustrated function exhibits abrupt steps for different values or ranges of values for achieved motor torque and steering wheel angle. However, a smooth function may also be used. For example, interpolation between values in a lookup table may be used. The illustrated function may correspond to a particular range of vehicle speeds with one or more different functions being defined for other vehicle speeds.

As is apparent in FIG. 5, the centering torque is relatively small, such as less than 5, 4, or 3 Newton-meters (Nm). The centering torque may be selected to be imperceptible, or at least not bothersome to a driver, while still being of sufficient magnitude to promote steering stability.

As is also apparent in FIG. 5, for achieved motor torques below a torque threshold, the centering torque is zero, such as torque threshold between 250 and 150, between 220 and 180, or about 200 Nm. Likewise, for steering wheel angles with a magnitude below an angle threshold, the centering torque may also be zero, such as an angle threshold less than 40 degrees, less than 35 degrees, or less than 30 degrees. Note that the relationship between steering wheel angle and the steering angle of the road wheels 306 may be different for different vehicles. Accordingly, the angle threshold may correspond to a steering angle of less than 10 degrees, less than 5 degrees, or less than 2 degrees.

Referring again to FIG. 4, the method 400 may include detecting, at step 412, driver torque, e.g., the torque exerted by the driver on the steering wheel 320 as sensed by the torque sensor 324. The method 400 may then include determining, at step 414, an assistance torque according to the driver torque and the centering torque. For example, step 414 may include combining the centering torque with a driver assistance torque that is a function of the driver torque. For example, the driver assistance torque may be a torque that is calculated as a function of some or all of the driver torque (e.g., increasing with increasing driver torque), vehicle speed (e.g., decreasing with increasing vehicle speed), and steering wheel angle (e.g., decreasing with increasing steering wheel angle). The assistance torque may therefore be a sum, weighted sum, or other combination of the driver assistance torque and the centering torque. The combination may take into account the signs of the driver torque and the centering torque.

For example, assume that a negative torque is torque to the left (inducing turning of the vehicle to the left), that a positive torque is to the right (inducing turning of the vehicle to the right). Assuming that a non-zero centering torque is determined according to the method 400, the following scenarios may occur:
Driver torque (D) is to the left and steering wheel angle is to the left->Centering torque (C) will be to the right, and the assistance torque (A∝f(D)+C) will be reduced in magnitude due to f(D), where f(D) is a function of the drive torque that outputs the drive assistance torque.
Driver torque is to the left and steering wheel angle is to the right->Centering torque will be to the left, and the assistance torque (A∝f(D)+C) will be increased in magnitude relative to f(D).
Driver torque is to the right and steering wheel angle is to the right->Centering torque will be to the left, and the assistance torque (A∝f(D)+C) will be reduced in magnitude relative to f(D).
Driver torque is to the right and steering wheel angle is to left->Centering torque (C) will be to the right, and the assistance torque (A∝f(D)+C) will be increased in magnitude relative to f(D).

Once the assistance torque is determined, the method 400 may include commanding, at step 416, the electric power steering actuator 322 to induce the assistance torque on the steering column 318. The electric power steering actuator 322 will attempt to apply the assistance torque to the steering column 318.

If, at step 404, the speed of the vehicle is not determined to be below the speed threshold, a centering torque is not applied in some embodiments. Accordingly, the method 400 may include detecting, at step 418, the driver torque (see description of step 414, above) and determining, at step 420, the assistance torque based on the driver torque and possibly other factors, such as steering wheel angle and vehicle speed. The assistance torque determined at step 420 may then be commanded at step 416 as described above. Note that, in some embodiments, explicit evaluation of vehicle speed with respect to a speed threshold is not performed. Instead, the function used to determine the centering torque may be zero above the speed threshold.

Where a different type of actuator is used, the method 400 may be modified accordingly. For example, the actuator providing power steering may be incorporated into the steering mechanism such that the assistance torque may be replaced with a translational assistance force exerted on the tie rods 314, the translational assistance force being a function of a centering force tending to urge the road wheels 306 to the central position and a driver assistance force corresponding to the driver torque. The centering force may be determined in the same manner as the centering torque described above. In embodiments in which the actuator providing power assistance is hydraulic, the assistance torque or translational assistance force may be controlled by opening one or more valves.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle comprising:
a chassis having a plurality of wheels mounted thereto, the plurality of wheels including a left steered wheel and a right steered wheel;
a drive motor configured to drive the left steered wheel and the right steered wheel to induce movement of the vehicle over a surface;
an assistance actuator configured to output an assistance torque;
a steering mechanism configured to transmit the assistance torque to the left steered wheel and the right steered wheel to change a steering angle of the left steered wheel and the right steered wheel;
a steering handle configured to be actuated by a driver of the vehicle; and
a controller coupled to the assistance actuator and to the steering handle, the controller configured to select the assistance torque based on:
a first component having a first magnitude and a first direction corresponding to a driver torque applied to the steering handle; and
a second component having a second magnitude and a second direction, the second direction corresponding to rotation of the left steered wheel and the right steered wheel toward a central position corresponding to movement of the vehicle in a straight line.

2. The vehicle of claim 1, wherein the controller is configured to select the second direction to correspond to movement of the left steered wheel and the right steered wheel toward the central position when (a) the first direction corresponds to rotation of the left steered wheel and the right steered wheel away from the central position and (b) the first direction corresponds to rotation of the left steered wheel and the right steered wheel toward the central position.

3. The vehicle of claim 1, wherein the controller is configured to select the second magnitude such that the second magnitude decreases with increasing speed of the vehicle.

4. The vehicle of claim 1, wherein the controller is configured to select the second magnitude such that the second magnitude increases with increasing output torque of the drive motor.

5. The vehicle of claim 1, wherein the controller is configured to select the second magnitude such that the second magnitude decreases with increasing speed of the vehicle and increases with increasing output torque of the drive motor.

6. The vehicle of claim 1, wherein the drive motor is coupled to the left steered wheel and the right steered wheel through a differential.

7. The vehicle of claim 1, wherein the controller is configured to select the second magnitude to be no more than 4 Newton-meters.

8. The vehicle of claim 1, wherein the controller is configured to select the second magnitude to be no more than 3 Newton-meters.

9. The vehicle of claim 1, wherein the steering handle is coupled to the steering mechanism by a steering column, the steering mechanism configured to transmit the driver torque applied to the steering handle to the left steered wheel and the right steered wheel.

10. The vehicle of claim 9, wherein the assistance actuator is an electric motor coupled to the steering column.

11. A method comprising:
detecting, by a controller of a vehicle, a first driver torque applied to a steering handle in a first handle direction while left and right steered wheels of the vehicle are offset in a first direction from a central position of the left and right steered wheels, the central position corresponding to movement of the vehicle in a straight line;
in response to detecting the first driver torque in the first handle direction, calculating, by the controller:
a first assistance torque as a function of the first driver torque, the first assistance torque having a first torque direction; and
a second assistance torque having a second torque direction opposite the first torque direction; and
causing, by the controller, an assistance actuator to apply a first combined torque to the left and right steered wheels of the vehicle, the first combined torque being a combination of the first assistance torque and the second assistance torque, the second torque direction corresponding to rotation of the left and right steered wheels to the central position.

12. The method of claim 11, wherein the first torque direction corresponds to rotation of the left and right steered wheels away from the central position.

13. The method of claim 12, further comprising:
detecting, by the controller, a second driver torque applied to the steering handle in a second handle direction opposite the first handle direction with the left and right steered wheels offset in the first direction from the central position;
in response to detecting the second driver torque in the second handle direction, calculating, by the controller:
a third assistance torque as a function of the second driver torque, the first assistance torque having the second torque direction; and
a fourth assistance torque having the second torque direction; and
causing, by the controller, the assistance actuator to apply a second combined torque to the left and right steered wheels of the vehicle, the second combined torque being a combination of the third assistance torque and the fourth assistance torque.

14. The method of claim 13, wherein the second assistance torque and the fourth assistance torque are both less than both of the first assistance torque and the third assistance torque.

15. The method of claim 14, wherein the second assistance torque and the fourth assistance torque are both less than four Newton-meters.

16. The method of claim 13, further comprising:
selecting, by the controller, the second assistance torque as a function of a first output torque of a drive motor driving the left and right steered wheels during application of the first driver torque; and
selecting, by the controller, the fourth assistance torque as a function of a second output torque of the drive motor during application of the second driver torque;
wherein the first output torque is greater than the second output torque, and the second assistance torque is greater than the fourth assistance torque.

17. The method of claim 16, wherein the left and right steered wheels are coupled to the drive motor by a differential.

18. The method of claim 13, further comprising:
selecting, by the controller, the second assistance torque as a function of a first speed of the vehicle during application of the first driver torque; and
selecting, by the controller, the fourth assistance torque as a function of a second speed of the vehicle during application of the second driver torque;
wherein the first speed greater than the second speed and the second assistance torque is less than the fourth assistance torque.

19. The method of claim 11, wherein the steering handle is coupled to a steering mechanism by a steering column, the steering mechanism configured to transmit an input torque applied to the steering handle to the left and right steered wheels.

20. The method of claim 19, wherein the assistance actuator is an electric motor coupled to the steering column.
